(19) United States
(12) Patent Application Publication
(10) Pub. No.: US 2017/0210895 A1
(43) Pub. Date: Jul. 27, 2017

(54) FORMING FREEZE-THAW-STABLE AQUEOUS DISPERSIONS

(71) Applicant: BASF SE, Ludwigshafen (DE)

(72) Inventors: Alexander CENTNER, Ludwigshafen (DE); Christian KRUEGER, Speyer (DE); Valerie WILMS, Mannheim (DE)

(73) Assignee: BASF SE, Ludwigshafen (DE)

(21) Appl. No.: 15/324,956

(22) PCT Filed: Jul. 8, 2015
(86) PCT No.: PCT/EP2015/065637

§ 371 Date: Jan. 9, 2017

(30) Foreign Application Priority Data
Jul. 10, 2014 (DE) 20 2014 005 635.8
Jul. 10, 2014 (EP) 14176543.8

(51) Int. Cl. C08L 33/08; C09J 133/08; B05D 7/02; B05D 1/02; B05D 1/18; B05D 3/02; C09D 133/08; C04B 26/06

(52) U.S. Cl. CPC C08L 33/08; C09D 133/08; C09J 133/08; C04B 26/06; B05D 1/02; B05D 1/18; B05D 3/0254; B05D 7/02; C08L 2201/54

(57) ABSTRACT

The invention relates to a method of forming a freeze-thaw-stable aqueous dispersion, a freeze-thaw-stable aqueous dispersion obtainable by the method of the invention, the use of said freeze-thaw-stable aqueous dispersion as a binder, a method of forming a shaped article by using the dispersion of the invention, and also a freeze-thaw-stable formulation.

The invention relates to a method of forming a freeze-thaw-stable aqueous dispersion, a freeze-thaw-stable aqueous dispersion obtainable by the method of the invention, the use of said freeze-thaw-stable aqueous dispersion as a binder, a method of forming a shaped article by using the dispersion of the invention, and also a freeze-thaw-stable formulation.

Aqueous compositions comprising saccharide are well known. U.S. Pat. No. 5,618,876 describes latex binders which are used to prepare freeze- and thaw-stable latex coating compositions which may be free of volatile freeze-thaw/open-time additives. The latex binders are prepared by combining a polymer which is the polymerization product of a polymerizable saccharide monomer with an acrylic monomer and optionally a monomer selected from the group consisting of a styrenic monomer, an ionic monomer and a wet adhesion monomer.

EP 0 276 770 A2 describes sizing agents for paper that are based on finely divided aqueous dispersions. The document describes sizing agents for paper that are based on finely divided aqueous dispersions of copolymers obtainable by copolymerizing from 40 to 140 parts by weight of a monomer mixture comprising (a) 20 to 65 wt % of (meth)acrylonitrile, (b) from 35 to 80 wt % of one or more acrylic esters of monohydric saturated C₃ to C₈ alcohols and (c) from 0 to 10 wt % of other ethylenically unsaturated copolymerizable monomers, wherein the weight percentages (a), (b) and (c) always sum to 100, in the manner of an emulsion polymerization in 100 parts by weight of an aqueous solution comprising in solution from 2.7 to 15 wt % of a degraded starch having a viscosity 0.04 to less than 0.12 dl/g at from 40 to 100° C. in the presence of an initiator comprising peroxide groups.

WO 2012/117017 A1 describes an aqueous binder composition comprising a) at least one chaing growth addition polymer P and at least one saccharide compound S. Said polymer P is constructed from various unsaturated monomers.

EP 0 536 597 A1 describes aqueous polymeric dispersions comprising sugared starch as well as polymers obtainable by free-radical polymerization of unsaturated monomers, and the use thereof. The aqueous polymeric dispersions described are more particularly aqueous dispersions of polymers obtainable by free-radical polymerization of unsaturated monomers and comprise at least one starch degradation product obtainable by hydrolysis in an aqueous phase and having a weight average molecular weight M_{w} of 2500 to 25 000.

Dispersions which, like water-in-oil emulsions, comprise water-soluble polymers dispersed therein are known in the prior art. Such emulsions have found a wide variety of uses, for example, as flocculants in the mining and paper industries and in wastewater treatment and as mobility control agents in enhanced oil recovery. Many of these applications occur in low-temperature environments, i.e., at below 0° C. and even as low as −20° C., where freezing of the emulsions before use is likely to occur. When such frozen emulsions are thawed for use, there is generally a problem of gel formation and/or a loss of product quality. To overcome this problem in the past, the art has been forced to add glycols or inorganic salts to depress the freezing point of the emulsions, or to reduce the amount of water-soluble polymer in the system for a given surfactant level, or to dehydrate the emulsion, or alternatively to use special expensive low-titer surfactants.

In view of the fact that all of these proposed solutions have resulted in either reducing the product performance or greatly increasing the cost of the resultant emulsions, there is a continuing need for a method of improving the freeze-thaw stability of such emulsions while at the same time minimizing the total amount of surfactant present in the system.

It is an object of the present invention to provide a method of forming improved aqueous dispersions as well as a freeze-thaw-stable aqueous dispersion obtainable thereby. These dispersions are advantageously free from freeze-thaw-stabilizing additives.

We have found that this problem is solved by a method of forming a freeze-thaw-stable aqueous dispersion comprising the steps of:
a) providing a mixture A comprising
   20-80 wt % of at least one ester from ethylenically unsaturated monomers A,
   20-80 wt % of at least one ethylenically unsaturated monomer B other than monomer A,
   0-6 wt % of at least one acid-functional ethylenically unsaturated monomer C, wherein, the overall amount of monomers A to C is 100 wt %,
b) providing 10-70 wt % of at least one saccharide compound S, based on the amount of monomers A to C to be polymerized,
c) providing water-soluble solvents and/or water W,
d) providing 0.1-2 wt % of at least one polymerization initiator I, based on the amount of monomers A to C to be polymerized,
e) polymerizing said monomers A to C in the presence of S, W and I to form a polymer P.

We have found that this problem is also solved by a freeze-thaw-stable aqueous dispersion obtainable by the method of the present invention.

It was found that the method which the present invention provides for forming a freeze-thaw-stable aqueous dispersion provides aqueous dispersions which are freeze-thaw-stable in that they do not coagulate after at least one freeze-thaw process.

One essential constituent of the dispersion is a polymer P constructed from
20-80 wt %, preferably 45-79.5 wt %, of at leastne ester fro ethylenically unsaturated monomers A,
20-80 wt %, preferably 20-50 wt %, of at least one ethylenically unsaturated monomer B other than monomer A,
0-6 wt %, preferably 0.5-5 wt %, of at least one acid-functional ethylenically unsaturated monomer C, wherein the overall amount of monomers A to C is 100 wt %.

It is particularly preferable for said polymer P to be constructed exclusively from the monomers A to C.

The polymer P and the water W, optionally the water-soluble solvent, are what forms the dispersion. The polymer P may be present therein in solid or liquid form. The polymer P is preferably in solid form. The dispersion of the present invention may also be referred to as an aqueous chain growth addition polymer dispersion or as an emulsion-type chain growth addition polymer.

Polymer P is obtained in a way with which a person skilled in the art has in-principle familiarity, for example by free-radical polymerization of monomers A to C by the method of, substance, emulsion, solution, precipitation or suspension polymerization, although free-radically initiated aqueous emulsion polymerization is particularly preferable. It is therefore advantageous according to the present invention for polymer P to be dispersed in an aqueous medium, i.e., for polymer P to be used in the form of an aqueous polymer dispersion. The performance of free-radically initiated emulsion polymerizations of monomers in an aqueous medium has been extensively described and therefore is sufficiently familiar to a person skilled in the art [cf. Emulsionspolymerisation in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer, F. Holscher, Springer-Verlag, Berlin (1969)]. A free-radically initiated aqueous emulsion polymerization is typically carried out by the ethylenically unsaturated monomers being dispersed in an aqueous medium, optionally by co-use of dispersing assistants, such as emulsifiers and/or protective colloids, and polymerized using at least one water-soluble free-radical polymerization initiator. Frequently, in the aqueous polymer dispersions obtained, the residual levels of unconverted ethylenically unsaturated monomers are reduced by chemical and/or physical methods likewise known to a person skilled in the art [see for example EP-A 771328, DE-A 19624299, BE-A 19621027, DE-A 19741 184, DE-A 19741 187, DE-A 19805122, DE-A 19828183, DE-A 19839199, DE-A 19840586 and 198471 15], the polymer solids content is adjusted to a desired value by thinning or concentrating, or the aqueous polymer dispersion is admixed with further customary added-substance materials, for example bactericidal, foam- or viscosity-modifying additives. From this general procedure, the method of forming an aqueous dispersion of polymer P in accordance with the present invention may merely differ by the specific use of the aforementioned monomers A to C. It will be appreciated in this connection that the method of forming polymer P herein shall also comprehend the seed, staged and gradient modes of operation which are familiar to a person skilled in the art.

Polymers P, obtainable by emulsion polymerization in particular, may preferably have glass transition temperatures Tg in the range from ≧−70 to ≦150° C. more preferably from ≧−20 to ≦40° C. and most preferably from ≧0 to ≦25° C.

By intentionally varying monomer type and quantity, a person skilled in the art who proceeds in accordance with the present invention is able to form polymeric dispersions, in particular chain growth addition polymers P, where the polymers have a glass transition temperature in the desired range. The glass transition temperature Tg herein is the midpoint temperature of ASTM D 3418-82. as determined by differential scanning calorimetry (DSC) [cf. also Ullman's Encyclopedia of Industrial Chemistry, page 169, Verlag Chemie, Weinheim, 1992 and Zosel in Farb; and Lack, 82, pages 125 to 134, 1976].

According to Fox (T. G. Fox, Bull. Am. Phys. Soc. 1956 [Ser. II] 1, page 123 and as per Ullmann's Encyclopädie der technischen Chemie, vol. 19, page 18, 4^{th} edition, Verlag Chemie Weinheim, 1980), the glass transition temperature of no more than lightly crosslinked copolymers is given to good approximation by:

1/Tg=x1/Tg1+x2/Tg2+ . . . xn/Tgn,

where x1, x2, . . . xn are the mass fractions of monomers 1, 2, . . . n and Tg1, Tg2, . . . Tgn are the glass transition temperatures in degrees Kelvin of the polymers constructed of just one of the monomers 1, 2, , . . . n. The glass transition temperatures of these homopolymers of most ethylenically unsaturated monomers are known (or are simple to determine experimentally in a conventional manner) and are listed for example in J. Brandrup, E. H. Immergut, Polymer Handbook 1st Ed, J. Wiley, New York, 1966, 2nd Ed. J. Wiley, New York, 1975 and 3rd Ed. J. Wiley, New York, 1989, and also in Ullmann's Encyclopedia of Industrial Chemistry, page 169, Verlag Chemie, Weinheim, 1992.

It will be appreciated in this connection that the method of forming polymer P herein shall also comprehend the seed, staged, shot and gradient modes of operation which are familiar to a person skilled in the art. The polymerization may be conducted as an in situ seed procedure, for example, or a polymer seed is employed as exogenous polymer seed.

For the purposes of the present invention, “freeze-thaw-stable” applies to a dispersion, in particular an aqueous dispersion, that does not coagulate after at least one freezing event and one thawing event. In the freezing event, the aqueous dispersion rigidifies into a solid material: in the thawing event, the frozen aqueous dispersion is brought to the same temperature as before it was frozen. At this thawing temperature, the formerly solid material is back in the form of an aqueous dispersion.

Suitable monomers A include, for example, conjugated aliphatic C₄ to C₉ diene compounds, esters from vinyl alcohol and a C₁ to C₁₀ monocarboxylic acid, C₁ to C₁₀ alkyl acrylate, C₅ to C₁₀ alkyl methacrylate, C₅ to C₁₀ cycloalkyl acrylate and methacrylate, C₁ to C₁₀ maleate and/or C₁ to C₁₀ dialkyl fumarate, vinyl ethers of C₃ to C₁₀ alkanols. It is particularly advantageous to use vinyl acetate, ethyl, acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl methacrylate, di-n-butyl maleate and di-n-butyl fumarate as monomers A, while 2-ethylhexyl acrylate, n-butyl acrylate, 1,4-butadiene, ethyl acrylate and mixtures thereof are particularly, preferable.

Mixture A preferably comprises 47-60 wt % of at least one ester from ethylenically unsaturated monomers A, most preferably from 50 to 56 wt % of at least one ester from ethylenically unsaturated monomers A and specifically 55 wt % of at least one ester from ethylenically unsaturated monomers A.

Suitable monomers B include, for example, vinylaromatic monomers and C₁ to C₄ alkyl methacrylates. Vinylaromatic monomers are, in particular, styrene, derivatives of styrene or of α-methylstyrene in each of which the phenyl rings are optionally substituted by 1, 2 or 3 C₁ to C₄ alkyl groups, halogen, in particular bromine or chlorine, and/or methoxy groups.

Suitable monomers B likewise include acrylonitrile, methacrylonitrile, maleonitrile and/or fumaronitrile, and acrylamide.

Particularly preferred monomers B are styrene, α-methylstyrene, o- or p-vinyltoluene p-acetoxystyrene, p-bromostyrene, p-tert-butylstyrene, o-, m- or p-chlorostyrene, methyl methacrylate, tert-butyl acrylate, tert-butyl methacrylate, ethyl methacrylate, isobutyl methacrylate, n-hexyl acrylate, cyclohexyl methacrylate, but also, for example, tert-butyl vinyl ether or cyclohexyl vinyl ether.

Styrene, tert-butyl methacrylate, methyl methacrylate or mixtures thereof are especially preferable for use as monomer B.

Mixture A preferably comprises 39-47 wt % of at least one ethylenically unsaturated monomer B other than monomer A, most preferably 42-46 wt % of at least one ethylenically unsaturated monomer B other than monomer A, and specifically 43 wt % of at least one ethylenically unsaturated monomer B other than monomer A.

Useful monomers C include any ethylenically unsaturated compounds having at least one acid group (proton donor), for example a sulfonic acid, phosphonic acid or carboxylic acid group, for example vinylsulfonic acid, allylsulfonic acid, styrenesulfonic acid, 2-acrylamidomethyl-propanesulfonic acid, vinyl phosphonic acid, allylphosphonic acid, styrenephosphonic acid and 2-acrylamido-2-methylpropanephosphonic acid. Advantageously, however, monomers C comprise of α,β-monoethylenically unsaturated, especially C₃ to C₆, preferably C₃ or C₄, mono- or dicarboxylic acids such as, for example, acrylic acid, methacrylic acid, ethylacrylic acid, itaconic acid, allylacetic acid, crotonic acid, vinylacetic acid, fumaric acid, maleic acid, 2-methylmaleic acid. However, monomers C also comprehend the anhydrides of corresponding α,β-monoethylenically unsaturated dicarboxylic acids, for example maleic anhydride or 2-methylmaleic anhydride.

Monomer C is preferably selected from the group comprising acrylic acid, methacrylic acid, crotonic acid, fumaric acid, maleic acid, maleic anhydride, 2-methylmaleic acid and itaconic acid, while acrylic acid, methacrylic acid and/or itaconic acid are particularly preferable. It will be appreciated that monomers C also comprehend the fully or partially neutralized water-soluble salts, in particular the alkali metal or ammonium salts, of the aforementioned acids.

Acrylic acid is particularly preferable for use as monomer C.

Mixture A preferably comprises 1-5 wt % of at least one acid-functional ethylenically unsaturated monomer C, most preferably 1.5-5 wt % of at least one acid-functional ethylenically unsaturated monomer C and specifically 2 wt % of at least one acid-functional ethylenically unsaturated monomer C.

The freeze-thaw-stable aqueous dispersions are obtainable by polymerizing monomers A to C by the method of free-radical aqueous emulsion polymerization in the presence of a saccharide compound S to be used according to the present invention. The emulsion polymerization temperature is generally in the range from 30 to 95° C., preferably in, the range from 75 to 90° C. The polymerization medium may consist not only of just water but also of mixtures of water and liquids miscible therewith, such as, methanol. It is preferable to use just water. The emulsion polymerization may be carried out not only as a batch process but also in the form of a feed process, including the staged or gradient method of operating a feed process. Preference is given to a feed process wherein a portion of the polymerization batch is initially charged, heated to the polymerization temperature, incipiently polymerized and then admixed with the rest of the polymerization batch, typically added via two or more spatially separate feeds, one or more of which comprise the monomers in pure form, for example, continuously or stagedly or under superposition of a concentration gradient while the polymerization in the polymerization zone is maintained. Owing to the high solubility in water of saccharide compound S used according to the present invention, a particularly simple way to conduct the feed process is for the total amount of saccharide compound S to be used to be initially charged in dissolved form in an aqueous initial charge; there is no need for pregelatinization. That is, the aqueous solution as obtained in the partial hydrolysis of the initial starch may—after the hydrolysis has been stopped, for example by neutralizing the catalytically active acid and cooling—be further used directly for the aqueous emulsion polymerization.

Those aqueous dispersions of the present invention which are obtainable by emulsion polymerization typically have a solids content of >10 and <70 wt %, frequently >20 and <65 wt % and often >25 and <60 wt %, all based on the aqueous polymer dispersion.

A saccharide compound S herein is to be understood as meaning monosaccharides, oligosaccharides, polysaccharides, sugar alcohols and also substitution products and derivatives thereof. The meaning of saccharide compound S for the purposes of the present invention also comprehends “sugared starch” or “saccharide”.

Monosaccharides are organic compounds of the generic formula CₙH₂ₙOₙ, where n is an integer 5, 6, 7, 8 or 9. These monosaccharides are also known as pentoses, hexoses, heptoses, octoses or nonoses, and these compounds can be subdivided into the corresponding aldoses, which include an aldehyde group, and ketoses, which include a keto group. Accordingly, monosaccharides comprise aldo- or ketopentoses, aldo- or ketohexoses, aldo- or ketoheptoses, aldo- or ketooctoses or aldo- or ketononoses. Monosaccharide compounds which are preferred according to the present invention are the pentoses and hexoses which also occur in nature, of which glucose, mannose, galactose and/or xylose are particularly preferable. It will be appreciated that the present invention also comprehends all stereoisomers of all aforementioned monosaccharides.

Starch degradation products obtainable with, a weight average molecular weight of 2500 to 25 000 g/mol by hydrolysis in aqueous phase are customarily referred to as sugared starches, in contradistinction to the roast dextrins, and are commercially available as such (for example from Cerestar Deutschland GmbH, D-1150 Krefeld 12).

One chemical difference between saccarides of this type and the roast dextrins is that with hydrolytic degradation in an aqueous medium (typically suspensions or solutions), generally performed at solids contents of 10 to 30 wt % and also, preferably under acid or enzymatic catalysis, there is essentially no possibility of recombination and branching, as is not least reflected in different molecular weight distributions.

The method of forming saccharide compound S (sugared starch) is common general knowledge and has been described, inter alfa in Günther Tegge, Stärke and Stärkederivate, Behr's Verlag, Hamburg 1984, p. 173 and p. 220 et seq., and also in EP-A 441 197. Saccharide compound S to be used according to the present invention is preferably a saccharide compound whose weight average molecular weight M_{w} is in the range from 4000 to 16 000 g/mol, more preferably; in the range from 6500 to 13 000 g/mol.

Saccharide compound S to be used according to the present invention is normally completely soluble in water at room temperature because the solubility limit is generally above 50 wt %, as will be found particularly advantageous when it comes to forming the aqueous dispersions of the present invention.

It will further be found advantageous for the saccharides S to be used according to the present invention to have a dispersity D (defined as the ratio of the weight average molecular weight M_{w} to the number average molecular weight Mₙ; D characterizes the molecular weight distribution) in the range from 6 to 12. It is particularly advantageous for D to be in the range from 7 to 11 and very particularly beneficial for D to be in the range from 8 to 10.

It is further advantageous when that weight fraction of saccharide compound S to be used according to the present invention that has a molecular weight below 1000 g/mol is not less than 10 wt % but not more than 70 wt %. It is particularly preferable for this weight fraction to be in the range from 20 to 40 wt %.

The initial starch used for forming saccharide compound S to be used according to the present invention may in principle be any native starch such as a cereal starch (e.g., corn (maize), wheat, rice or millet), a tuber or root starch (e.g., potatoes, tapioca roots or arrowroot) or a sago starch.

One significant advantage of saccharide compound S is that, apart from the very simple-to-perform partial hydrolysis of the initial starch to form the saccharide compound S, it requires no further chemical modification to be useful. It will be appreciated, however, that it may also be used in the present invention in a chemically modified form as results from etherification or esterification for example. This chemical modification may also have already been performed on the initial starch prior to the degradation thereof. Esterifications are possible not only with inorganic but also with organic acids, their anhydrides or chlorides. Phosphated and acetylated degraded starches are of particular interest. The most commonly employed method of etherification involves the treatment with organic halogen compounds, epoxides or sulfates in aqueous alkaline solution. Alkyl ethers, hydroxyalkyl ethers, carboxyalkyl ethers and allyl ethers are particularly suitable ethers. Reaction products with 2,3-epoxipropyltrimethylammonium chloride also come into consideration.

A chemically unmodified saccharide compound S is preferable.

Saccharide compound S generally has a weight average molecular weight in the range >1000 and <5 000 000 g/mol, advantageously in the range >1000 and <500 000 g/mol, preferably in the range >3000 and <50 000 g/mol and more preferably in the range >5000 and <25 000 g/mol. Weight average molecular weight is determined using gel permeation chromatography with defined standards which is familiar to a person skilled in the art.

Preferably, saccharide compound S has a solubility of >10 g, advantageously >50 g and more advantageously >100 g per liter of deionized water at 20° C. and atmospheric pressure. The present invention, however, also comprehends embodiments where saccharide compound S has a solubility <10 g per liter of deionized water at 20° C. and atmospheric pressure. Depending on the amount of these employed saccharide compounds S, these can then also be present in the form of their aqueous suspension. When a saccharide compound S is employed in such a type and amount that it is in the form of an aqueous suspension, it is advantageous for the saccharide compound S particles suspended in the aqueous medium to have an average particle diameter of ≦5 μm, preferably ≦3 μm and more preferably ≦1 μm. Average particle diameters are determined via the method of quasi-elastic light scattering (ISO standard 13 321).

The total amount of saccharide compound S may be added to the aqueous polymerization medium (monomers A to C, water and optionally initiator) before, during or after the emulsion polymerization of monomers A to C of the emulsion polymerization of the aqueous dispersion of polymer P. As will be appreciated, it is also possible to add merely a portion of saccharide compound S to the aqueous polymerization medium before or during the emulsion polymerization of monomers A to C and the remainder to the aqueous dispersion of polymer P on completion of the emulsion polymerization. When all or some of saccharide compound S is added before or during the emulsion polymerization of monomers A to C, the amount added may generally perform the protective colloid function, making it possible to reduce the amount of other protective colloids and/or emulsifiers, or optionally to eschew these entirely. Advantageously, therefore, only small amounts of monomer C are also employed, since these may likewise function as a protective colloid once they are in the polymeric form.

The method of forming a freeze-thaw-stable aqueous dispersion comprises the step of providing water-soluble solvents and/or water W. Preferred water-soluble solvents are alcohols, for example methanol or ethanol. W here stands for water-soluble solvents, for water or for both.

The method of forming a freeze-thaw-stable aqueous dispersion comprises the step of providing 0.1-2 wt % of at least one polymerization initiator I, based on the amount of monomer A to C to be polymerized. It is advantageous to provide from 0.12 to 0.18 wt % of at least one polymerization initiator I.

Useful polymerization initiators include all those capable of initiating a free-radical aqueous polymerization, in particular an emulsion polymerization. Not only peroxides, e.g., alkali metal peroxodisulfates or H₂O₂, but also azo compounds may be concerned here.

Useful polymerization initiators also include combined systems made up of at least on organic reducing agent arid at least one peroxide and/or hydroxide, e.g., tert-butyl hydroperoxide and the sodium metal salt of hydroxymethanesulfinic acid or hydrogen peroxide and ascorbic acid.

Useful combined systems further include those comprising a small amount of a metal compound that is soluble in the polymerization medium and the metallic component of which can occur in two or more valency states, e.g., ascorbic acid/iron(II) sulfate/hydrogen peroxide, although the sodium metal salt of hydroxymethanesulfinic acid, sodium sulfite, sodium hydrogensulfite or sodium metal bisulfite are also frequently used instead of ascorbic acid and tert-butyl hydroperoxide or alkali metal peroxodisulfates and/or ammonium peroxodisulfates are also used instead of hydrogen peroxide. When combined systems are employed, it may be advantageous to use saccharide compound S the reducing component.

The amount of free-radical initiator systems used is generally in the range from 0.1 to 2 wt %, based on the overall amount of monomers to be polymerized.

It is particularly preferable to use ammonium peroxodisulfate and/or alkali metal peroxodisulfates as such or as constituent part of combined systems, as polymerization initiator I. The use of sodium peroxodisulfate is particularly preferred.

The manner in which the polymerization initiator I is added to the polymerization vessel in the course of the aqueous emulsion polymerization of the present invention is more of minor importance. It may not only be fully included in the initial charge into the polymerization vessel but also be added continuously or stagedly at the rate of its consumption in the course of the aqueous emulsion polymerization. As a person having ordinary skill in the art will know, this depends in any one case not only on the chemical nature of the initiator system but also on the polymerization temperature. The preferred procedure is to include a portion in the initial charge and to feed the remainder to the polymerization zone at the rate of consumption.

It will be appreciated that the (free-radical) aqueous emulsion polymerization may also be carried out under elevated or reduced pressure.

A method which is particularly preferable for the purposes of he present invention comprises the steps of:
a) providing a mixture A comprising
   20-79.5 wt % of at least one ester from ethylenically unsaturated monomers A,
   20-80 wt % of at least one ethylenically unsaturated monomerB other than monomer A,
   0.5-5 wt % of at least one acid-functional ethylenically unsaturated monomer C, wherein the overall amount of monomers A to C is 100 wt %,
b) providing 20-55 wt % of at ₗₑₐₛₜ one saccharide compound S, based on the amount of monomers A to C to be polymerized,
c) providing 20-150 wt % of water-soluble solvents and/or water W, based n the amount of monomers A to C to be polymerized,
d) providing 0.1-2 wt % of at least one polymerization initiator I, based on the amount of monomers A to C to be polymerized,
e) polymerizing said monomers A to C in the presence of S, W and I to form a polymer P.

Particular preference is given to a method of forming a dispersion in the manner of the present invention that comprises the steps of:
a) providing a mixture A consisting of
   20-79.5 wt % of at least one ester from ethylenically unsaturated monomers A,
   20-80 wt % of at least one ethylenically unsaturated monomer B other than monomer A,
   0.5-5 wt % of at least one acid-functional ethylenically unsaturated monomer C, wherein the overall amount of monomers A to C is 100 wt %,
b) providing 20-55 wt % of at least one saccharide compound S, based on the amount monomers A to C to be polymerized,
c) providing 20-150 wt water-soluble solvents and/or water W, based on the amount of monomers A to C to be polymerized,
d) providing 0.1-2 wt % of at least one polymerization initiator I, based on the amount of monomers A to C to be polymerized,
e) polymerizing said monomers A to C in the presence of S, W and I to form a polymer P.

Especial preference is given to a method of forming a dispersion in the manner of the present invention that comprises the steps of:
a) providing a mixture A consisting of
   20-79.5 wt % of at least one ester from ethylenically unsaturated monomers A,
   20-80% of at least one ethylenically unsaturated monomer B other than monomer A,
   0.5-5 wt % of at least one acid-functional ethylenically unsaturated monomer C, wherein the overall amount of monomers A to C is 100 wt %,
b) providing 35-55 wt % of at least one saccharide compound S, based on the amount of monomers A to C to be polymerized,
c) providing 20-150 wt % of water-soluble solvents and/or water W, based on the amount of monomers A to C to be polymerized,
d) providing 0.1-2 wt % of at least one polymerization initiator I, based on the amount of monomers A to C to be polymerized,
e) polymerizing said monomers A to C in the presence of S, W and I to form a polymer P.

In a particularly preferred embodiment of the method according to the present invention, said dispersion is free from freeze-thaw-stabilizing additives.

Saccharide compound S used in the method of the present invention may be employed as sole dispersant. Further freeze-thaw-stabilizing additives may accordingly be eschewed.

Useful freeze-thaw-stabilizing additives include, for example, the emulsifiers and protective colloids otherwise customarily used as dispersants. A detailed description of suitable protective colloids is found in Houben-Weyl, Methoden der organischen Chemie, volume XIV/1, Makromolekulare Stoffe, Georg-Thieme-Verlag, Stuttgart, 1961, pages 411 to 420. Useful freeze-thaw-stabilizing additives include not only anionic and cationic but also nonionic emulsifiers. Customary freeze-thaw-stabilizing additives include, for example, ethoxylated fatty alcohols (degree of ethoxylation: 3 to 50, alkyl: C₈ to C₃₆), ethoxylated mono-, di- and tri-alkylphenols (degree of ethoxylation: 3 to 50, alkyl: C₄ to C₉), alkali metal salts of dialkyl esters of sulfosuccinic acid and also alkali metal and ammonium salts of alkyl, sulfates C₈ to C₁₂), of ethoxylated alkanols (degree of ethoxylation: 4 to 30, alkyl: C₁₂ to C₁₈), of ethoxylated alkylphenols (degree of ethoxylation: 3 to 50, alkyl C_{4 to} C₉), of alkylsulfonic acids (alkyl: C₁₂ to C₁₈) and of alkylarylsulfonic acids (alkyl: C₉ to C₁₈). Further suitable emulsifiers are found in Houben-Weyl, Methoden der organischen Chemie, volume XIV/1, Makromolekulare Stoffe, Georg Thieme Verlag, Stuttgart, 1961, pages 192 to 208. By way of further freeze-thaw-stabilizing additives, in particular in formulations, a person skilled in the art is aware of glycols, for example diethylene glycol, ureas or glycerol. Preferably, the dispersion does not contain any aforementioned additive.

By way of saccharide compound S, the method of the present invention preferably employs starch and/or starch derivatives/substitution products thereof, for example maltodextrin and/or glucose syrup.

In a preferred method of the present invention, saccharide compound S is maltodextrin. Said maltodextrin may be a maltodextrin solution or spray-dried maltodextrin.

Preferred maltodextrins for the purposes of the present invention have DE values in the range from 3 to 20 and weight average molecular weights of 15 000 to 30 000 g/mol. A glucose syrup which is likewise preferred for the purposes of the present invention has DE values of 20 to 30 and weight average molecular weights in the range from 3000 to 9000 g/mol. Owing to their method of making, these products are obtained in the form of aqueous solutions and therefore are generally also marketed as such. Solids contents are in the range from 50 to 70 wt % for suitable solutions of maltodextrins and in the range from 70 to 95 wt % for suitable solutions of glucose syrup. Maltodextrins in particular, however, are also available in a spray-dried, pulverulent form.

In a preferred method of the present invention, saccharide compound S has a dextrose equivalent (DE) value in the range from 10 to 40. The DE value of saccharide compound S is in the range from 16 to 35 in particular, more preferably in the range from 15 to 20.

The DE value characterizes he reducing power relative to the reducing power of anhydrous dextrose and is determined as specified in DIN 10308 Issue 5.71, prepared by Technical Committee for Foodstuffs and Agricultural Products (cf. also Günther Tegge, Stärke und Stärkederivate, Behr's Verlag, Hamburg 1984, p. 305).

Preference is given to a method of the present invention wherein saccharide compound S has a pH in a value of 4 to 5 when in the form of a 50 wt % solution.

The method of forming a freeze-thaw-stable aqueous dispersion may be carried out continuously, semi-continuously or batchwise.

Preference is given to a method of the present invention wherein the method is carried out semi-continuously.

To form polymer P as its aqueous polymer dispersion, total monomers A to C may be initially charged in the aqueous reaction medium prior to initiating the polymerization reaction.

It is also possible, however, to optionally merely include a portion of monomers A to C as an initial charge in the aqueous reaction medium before initiating the polymerization reaction and then, after initiating the polymerization, to add the total amount or, as may be, the remaining quantity under polymerization conditions during the free-radical emulsion polymerization at the rate of consumption, continuously with constant or varying flow rates, or discontinuously (semi-continuous method). Monomers A to C may here be dosed as separate individual streams, as homogeneous or inhomogeneous (partial) mixtures, or as a monomeric emulsion. Advantageously, monomers A to C are dosed in the form of a monomer mixture, in particular in the form of an aqueous monomeric emulsion.

The method preferably comprises a step f) of adding from 0.05 to 0.20 of H₂O₂, based on the amount of monomers A to C to be polymerized after step e).

The method preferably comprises in step f) the addition of 0.05 to 0.02 wt % of ascorbic acid, based on the amount of monomers A to C to be polymerized, and 1.5-4 wt % of water W1, based on the amount of monomers A to C to be polymerized. Water W1 may be present in the dispersion in addition to water W.

Step f) of the method may advantageously comprise adding 0.05-0.02 wt % of H₂O₂ and adding 0.05-0.02 wt % of ascorbic acid and 1.5-4 wt % of water W1 (all based on the amount of monomers A to C to be polymerized). This is an advantageous way of effecting a form of chemical deodorization. Said chemical deodorization may more particularly be effected in a temperature range of 60 to 100° C., in particular in the range from 80 to 95° C.

In a preferred embodiment of the method according to the present invention, 5-15 wt % of the total of mixture A and 4-8 wt % of the total of polymerization initiator I and 25-35 wt % of the total of water W are provided and polymerized and within 6 h the remainder of mixture A, of polymerization initiator I and of water W is added. The remainder of mixture A, of polymerization initiator I and of water W is advantageously added within 4 h, especially within 2 h.

In a preferred embodiment of the method according to the present invention, the aqueous dispersion is exposed to at least one freeze-thaw process. Preferably, the aqueous dispersion is exposed to at least three thaw-freeze processes. This step makes it possible to screen out faulty batches in advance in the manufacturing process making it possible to produce freeze-thaw-stable aqueous dispersions that possess an appropriate degree of long-term stability. Moreover, a dispersion that does not coagulate after at least one freeze-thaw process makes it possible to provide a formulation that likewise does not coagulate after a freeze-thaw process. Dispersions or formulations of this type can therefore be shipped to cold regions and also stored there without their properties suffering. This can lead to reduced costs, since there is no need for appropriate thermal transportation and temperature-regulated warehouses.

Preferably, the aqueous dispersion obtainable by the method of the present invention is exposed to at least one freeze-thaw process wherein the aqueous dispersion is maintained at a temperature in the range from 0 to −40° C. for from 30 min to 48 h and then rethawed at a temperature of 1-50° C. for from 30 min to 48 h.

The invention further provides a freeze-thaw-stable aqueous dispersion obtainable by the method of the present invention.

The aqueous dispersion of the present invention has very many possible uses. It is especially useful as an adhesive, as a binder for carpetback coatings, as a binder for papercoating slips, as an add in mineral, e.g., hydraulically setting, binders, as a sizing agent for fibers, as a binder for finely divided mineral and/or organic materials for forming shaped articles (e.g., flakeboard), in particular for metal casting or paints and renders, as a thickener and also as a binder for forming abrasive products based on finely divided abrasive particles bonded to each other and/or to a backing. Of particular advantage here are the enhanced filming capacity of the aqueous dispersion according to the present invention and also the enhanced tensile strength of the films resulting from the filming process.

The aqueous dispersion of the present invention is particularly useful as a binder for foundry sands to form cores and molds for metal casting, to form ingot mold insulation board based on finely divided paper and optionally finely divided mineral materials and also to form abrasive products based on finely divided abrasive particles bound to each other and/or to a backing by means of a binder. Suitable foundry sand consists generally of granular quartz sand, but also in certain cases of chromite sand, zircon sand or olivine sand. In addition chamotte, magnesite, sillimanite or corundum materials are also used. The average largest diameter of a particle is normally in the range from 0.05 to 0.6 mm. The foundry sands are generally converted into foundry moldings by mixing the sands with the aqueous dispersions of the present invention while establishing the desired binder content, generally (reckoned dry) from 0.1 to 10, preferably from 0.1 to 5, wt %, based on the amount of foundry sand, introducing the mixture (known as mortar in this field) into a mold (negative), optionally applying a compacting pressure and then curing. It is remarkable that, on using the dispersions of the present invention, which for this purpose are typically used with a total solids content of 40 to 60 wt %, the curing process does not necessarily require the employment of elevated temperatures (normally 50 to 250° C.), but that through-curing will take place at a satisfactory rate even when left to itself at room temperature. Through-curing is also achievable in a technically particularly neat manner by exposing the material to be cured to the action of microwaves.

The dispersion of the present invention is particularly useful for forming abrasive products based on finely divided abrasive particles bound to each other and/or to a backing by means of a binder. As finely divided abrasive particles there may be used in particular: fused or sintered corundum, zircon corundum, silicon carbide and emery. Useful backing materials include flexible support materials such as, for example, paper, vulcanized fiber, woven fabrics, knitted fabrics, nonwoven fabrics based on natural and/or synthetic fibers, self-supporting plastics film/sheet or metal foils. In general, abrasive products of this type are formed by coating the backing initially with a so-called make coat, into which the abrasive particles are embedded in the wet state. After initially fixing the abrasive grain by drying (curing), a second, so-called size coat is generally applied to improve the embedment and attachment of the grain. In principle, the make and size coats may consist of different binders. In effect, the aqueous dispersion may constitute at least one size coat. Typical requirements of binders useful for forming abrasive products include for example:
good adherence, both to the base and to the abrasive particle
rapidly curable under benign conditions
minimal imposition of stress on the backing material
high heat resistance
enhanced flowability at the time of application
good mechanical properties during sanding (formation of hard, tough, films).

The dispersion of the present invention meets these requirements in full. Its cure, for instance, does not necessarily require elevated temperatures, but can take place at room temperature and with particular advantage by the action of microwaves. This is, in particular, gentle on the backing material and avoids extreme removal of water, obviating the need for complicated regeneration procedures for the backing material in climatic zones.

The favorable flow behavior of the freeze-thaw-stable aqueous dispersion proves to be particularly advantageous when the dispersion is used as a size coat, since this enables the binder to penetrate into the interstices between the abrasive grains.

Particular preference is given to a freeze-thaw-stable aqueous dispersion of the present invention that is free from freeze-thaw-stabilizing additives. The freeze-thaw-stabilizing additives were recited above.

The invention further relates to the method of using the freeze-thaw-stable aqueous dispersion of the present invention as a binder for coatings, sealants, cementitious coatings, noncementitious coatings, adhesives and primers. Examples of noncementitious coatings are flexible coating for roofs, wetroom coatings or mortar compositions, of sealants are joint sealants and of adhesives are assembly adhesives, tile adhesives, contact adhesives or floorcovering adhesives. Primers are known to a person skilled in the art and serve, for example, to prepare coarsely porous, absorbent and sandy substrates. Examples of cementitious coatings are cementitious waterproofing grouts, renders, mortars or floor screeds.

It is particularly preferable to use the freeze-thaw-stable aqueous dispersion of the present invention as a binder for noncementitious coatings, adhesives and primers. The primers are preferably also freeze-thaw-stable.

The invention further provides the method of using the freeze-thaw-stable aqueous dispersion of the present invention as a cold- and/or heat-resistant binder for coatings, sealants, cementitious coatings, noncementitious coatings, adhesives and primers. A cold- and/or heat-resistant binder is a binder that rigidifies in the course of a freezing event, advantageously at a temperature of 0° C. to 30° C., and does not coagulate in the course of a thawing event, in particular at a temperature of 0 to 50° C. More particularly, the binder does not coagulate in the presence of further additives present in the use as a binder.

It is particularly preferable to use the freeze-thaw-stable aqueous dispersion of the present invention as a cold- and/or heat-resistant binder for noncementitious coatings, adhesives and primers. The primers are preferably also freeze-thaw-stable.

When the freeze-thaw-stable aqueous dispersion of the present invention is used in the manner of the present invention, customary auxiliary or added-substance materials may additionally also be included in the type and amount with which a person skilled in the art is familiar for the particular use.

Auxiliary or added-substance materials may preferably be selected from the group consisting of a thickener, a biocide, a defoamer, a filming assistant, a wetting agent, a water-soluble organic solvent, a pigment and a filler.

Advantageously, no further freeze-thaw-stabilizing additives are involved when a freeze-thaw-stable aqueous dispersion is used as a binder. Freeze-thaw-stabilizing additives were recited above.

The invention further provides a method of forming a shaped article from granular and/or fibrous substrates which comprises applying a freeze-thaw-stable dispersion obtainable by the method of the present invention or a freeze-thaw-stable aqueous dispersion of the present invention to the granular and/or fibrous substrate, optionally shaping the granular and fibrous substrate thus treated and then subjecting the granular and/or fibrous substrate thus obtained to a thermal treating step at a temperature ≧110° C.

Granular and/or fibrous substrates are familiar to a person skilled in the art. Examples are wood chips, wood fibers, cellulose fibers, textile fibers, plastics fibers, glass fibers, mineral fibers or natural fibers, such as jute, flax, hemp or sisal, but also cork chips or sand and also other organic or inorganic naturally and/or synthetic granular and/or fibrous compounds whose longest dimension in the case of granular substrates is ≦10 mm, preferably ≦5 mm and more preferably ≦2 mm. It will be appreciated that the term substrate shall also comprehend the fibrous webs obtainable from fibers, for example so-called mechanically consolidated, for example needled or chemically prebonded fibrous webs. The freeze-thaw-stable aqueous dispersion of the present invention is particularly useful as a formaldehyde-free binder system for the aforementioned fibers and mechanically consolidated or chemically prebonded fibrous webs.

The essential components of the dispersion according to the present invention, i.e., the aqueous dispersion of polymer P and saccharide compound S, especially in the form of its solution or suspension, may be mixed homogeneous before application to the granular and/or fibrous substrate. It is also possible to mix the two components only immediately before application, for example with a static and/or dynamic mixing device. It is also possible to first apply the aqueous dispersion of polymer P and then the aqueous solution or suspension of saccharide compound S to the granular and/or fibrous substrate, in which case the mixing takes place on the granular and/or fibrous substrate. Similarly, however, it is also possible first to apply the aqueous solution or suspension of saccharide compound S and then the aqueous dispersion of polymer P to the granular and/or fibrous substrate. It will be appreciated that hybrid forms of applying the two essential components shall also be comprehended.

Impregnating the granular and/or fibrous substrate may generally take the form of the freeze-thaw-stable aqueous dispersion being applied uniformly to the surface of the fibrous and/or granular substrate. The amount of aqueous dispersion is chosen such that, per 100 g of granular and/or fibrous substrate, ≧1 g and ≦100 g, preferably ≧2 g and ≦50 g and more preferably ≧5 g and ≦30 g of binder (reckoned as summed total amounts of polymer P and saccharide compound S on solids) are used. The actual method of impregnating the granular and/or fibrous substrate is familiar to a person skilled in the art and is effected for example, by drenching or spraying the granular and/or fibrous substrate.

After impregnation, the granular and/or fibrous substrate is optionally formed into a desired shape, for example by introduction into a heatable press or mold. Thereafter, the shaped impregnated granular and/or fibrous substrate, is dried and cured in a manner familiar to a person skilled in the art.

Drying/curing the optionally shaped impregnated granular and/or fibrous substrate frequently takes place in two temperature, stages, with the drying stage being carried out at a temperature <100° C., preferably ≧20° C. and ≦90° C. and more preferably ≧40° C. and ≦80° C. and the curing stage at a temperature ≧110° C., preferably ≧130° C. and ≦250° C. and more preferably ≧180° C. and ≦220° C.

However, it is self-evidently also possible for the drying stage and the curing stage of the shaped articles to take place in one operation, for example in a molding press.

The shaped articles obtainable by the method of the present invention have advantageous properties, in particular an improved transverse breaking strength and also a distinctly lower transverse elongation at 180° C. compared with the shaped articles of the prior art.

The freeze-thaw-stable aqueous dispersion according to the present invention is therefore particularly advantageous for forming fibrous webs based on polyester and/or glass fiber, which in turn are particularly useful for forming bituminized roofing membranes.

The actual method of forming bituminized roofing membranes is familiar to a person skilled in the art and is more particularly performed by applying liquefied, optionally modified, bitumen to one and/or both of the sides of a polyester and/or glass fiber web bonded with the dispersion of the present invention.

The invention further provides a freeze-thaw-stable formulation comprising the freeze-thaw-stable dispersion of the present invention, at least one pigment disperser, at least one filler and at least one thickener.

Particular preference is given to a freeze-thaw-stable formulation comprising
1-99.9 wt % of freeze-thaw-stable aqueous dispersion according to the invention,
0-5 wt % of at least one pigment disperser,
0-80 wt % of at least one filler,
0.1-10 wt % of at least one thickener, and
0-5 wt % of at least one additive,
   wherein the components sum to an overall amount of 100 wt %.

Especial preference is given to a freeze-thaw-stable formulation comprising
5-45 wt % of freeze-thaw-stable aqueous dispersion according to the invention,
0.1-3 wt % of at least one pigment disperser,
50-75 wt % of at least one filler,
0.1-5 wt % of at least one thickener, and
0-20 wt % or at least one additive, wherein the amount may be inclusive of water,
   and wherein the components sum to an overall amount of 100 wt %.

Very particular preference is given to a freeze-thaw-stable formulation comprising
39.8-70 wt % of freeze-thaw-stable aqueous dispersion according to the invention,
0.1-5 wt % of at least one pigment disperser,
20-60 wt % of at least one filler,
0.1-10 wt % of at least one thickener, and
0-20 wt % of at least one additive, wherein the amount may be inclusive of water,
   and wherein the components sum to an overall amount of 100 wt %.

Particular preference is given to a freeze-thaw-stable formulation consisting of
1-99.9 wt % of freeze-thaw-stable aqueous dispersion according to the invention,
0-5 wt % of at least one pigment disperser,
0-80 wt % of at least one filler,
0.1-10 wt % of at least one thickener, and
0-5 wt % of at least one additive,
   wherein the components sum to an overall amount of 100 wt %.

Especial preference is given to a freeze-thaw-stable formulation consisting of
5-45 wt % of freeze-thaw-stable aqueous dispersion according to the invention,
0.1-3 wt % of at least one pigment disperser,
50-75 wt % of at least one filler,
0.1-5 wt % of at least one thickener, and
0-20 wt % of at least one additive, wherein the amount may be inclusive of water,
   and wherein the components sum to an overall amount of 100 wt %.

Very particular preference is given to a freeze-thaw-stable formulation consisting of
39.8-70 wt % of freeze-thaw-stable aqueous dispersion according to the invention,
0.1-5 wt % of at least one pigment disperser,
20-60 wt % of at least one filler,
0.1-10 wt % of at least one thickener, and
0-20 wt % of at least one additive, wherein the amount may be inclusive of water,
   and wherein the components sum to an overall amount of 100 wt %.

The freeze-thaw-stable formulation of the present invention may further also comprise customary auxiliary or added-substance materials in the type and amount with which a person skilled in the art is familiar for the particular use.

Auxiliary or added-substance materials may preferably be selected from the group consisting of a biocide, a defoamer, a filming assistant, a wetting agent, a water-soluble organic solvent and a pigment.

Preferred biocides include, for example, chloromethylisothiazolinone, 2-methyl- or 1,2-benzisothiazolinone and also mixtures thereof, for example Acticid® MV or Acticid® MBS 2550.

Preferred defoamers include, for example, mineral/silicone oil defoamers and alkoxylated compounds, for example Agitan® 282 Agitan® E255, Byk® 93 or Lumiten® EL.

Preferred filming assistants include, for example, white spirit, Texanol®, butyldiglycol, dipropylene glycol monobutyl ether (Solvenon® DPnB), tripropylene glycol monobutyl ether (Solvenon® TPnB), butyldiglycol acetate or methyldiglycol.

Preferred wetting agents include, for example, 2-aminopropanol, acetylenediols, polyphosphonates. Emulsifiers such as, for example, Lumiten I-SC may also be used as wetting agents and emulsifiers such as Emulphor FAS 30 or Lutensol TO 89 may be used to improve shelf life (viscosity change/phase separation).

Preferred water-soluble organic solvents include, for example, methanol, ethanol, isopropanol, acetone.

Preferred pigment dispersers include, for example polymers based on carboxylic acids, example Pigmentverteiler® NL, Pigmentverteiler® MD20, Dispex® N40 or Dispex® G40.

Preferred thickeners include, for example, thickeners based on polyacrylates, polyurethanes or polysaccharides, such as Borchigel® L75, Tafigel® PUR 40, Viscalox® HV 30, Walocel® MW 40000, Latekoll® D or Latekoll® DS 6269.

Preferred fillers/pigments (pigment dispersers) are known to a person skilled in the art and are itemized for example in “Pigment- und Füllstoff-Tabellen”, Lückert, (2002) Vincentz Verlag.

Preferred fillers and additives include particularly aluminum silicates, quartz, precipitated or pyrogenous silica, which may be hydrophobicized, light and heavy spar, talc, dolomite, calcium carbonate and also color-conferring pigments such as titanium white, lead white, chromium yellow, red lead, zinc yellow or carbon black and also calcium silicate, barium sulfate, magnesium carbonate and magnesium silicate.

Examples of further inorganic fillers include filler particles of andalusite, silimanite, kyanite, mullite, pyrophylite, omogolite or allophane. Additionally suitable are compounds based on sodium aluminates, silicates, e.g., aluminum silicates, calcium silicates or silicas (e.g., Aerosil®). Likewise suitable are minerals such as siliceous earth, calcium sulfate (gypsum), that does not come from flue gas desulfurizers in the form of anhydrite, hemihydrate or dehydrate, quartz meal, silica gel, precipitated or natural barium sulfate, titanium dioxide, zeolites, leucite, potash feldspar, biotite, the group of soro-, cyclo-, ino-, phyllo- and tectosilicates, the group of sparingly soluble sulfates, such as gypsum anhydrite or barite, and also calcium minerals, such as calcite.

The recited inorganic minerals may be used singly but also in admixture. Further suitable materials are precipitated or natural kaolin, talc, magnesium hydroxide or aluminum hydroxide (to establish the fire class), expandable graphite, sheet-silicates, zinc oxide and also zirconium salts. Through addition of lightweight fillers—hollow ceramic microbeads, hollow glass beads, foam glass beads, expanded/nonexpanded polystyrene or other lightweight fillers of the type manufactured by Omega-Minerals for example—parameters such as dimensional stablility and density can be influenced.

Filler particles have an average particle size distribution with an x50 value of about 1 to 120 μm, for example about 3 to 60 or about 60 to 90 μm as measured using Sympatec® Helos H 0720 in isopropanol.

Organic particles of filler are likewise suitable for use. These include, in particular, finely ground polymeric meals as may be generated in the recycling of plastics and polymeric meals as obtainable from finely grinding highly crosslinked elastomeric or thermoset polymers. Rubber meal as formed by finely grinding car tires for example is one example. Filler particles further include polymeric fibers, impact modifiers, cellulose fibers or glass fibers (e.g., Wollastonit® products).

Aforementioned embodiments and preferred embodiments are all freely combinable with one another unless the context clearly suggests otherwise.

The examples which follow illustrate the invention.

### EXAMPLES

Material and Methods

The following components were used:

n-butyl acrylate (nBA)

styrene (S)

acrylic acid (AA)

2.5 wt % aqueous solution of sodium peroxodisulfate (2.5% NaPS solution)

spray-dried maltodextrin from the enzymatic conversion of corn starch (C Dry MD01915; C Dry)

Disponil LDBS20 (sodium n-alkyl(C10-C13)benzenesulfonic acid)

SC (solids content)

### Comparative Example 1

A mixture consisting of 427.5 g of water, 100 g of spray-dried maltodextrin (DE value 16.5-19.9, 20 wt %), 50 g of feed 1 and 32 g of feed 2 was heated to 85° C. and maintained at 85° C. for 15 min. Then, while maintaining the 85° C. and starting at the same time, the remaining amounts of feeds 1 and 2 were added to the polymerization zone continuously (within 2.5 h for feed 1, within 3 h for feed 2). This was followed by an hour of secondary polymerization at 85° C.
Feed 1: 275 g of n-butyl acrylate (55 wt %)
   215 g of styrene (43 wt %)
   10 g of acrylic acid (2 wt %)
Feed 2: 160 g of 25 wt % aqeous olufion of sodium peroxodisulfate (0.8 wt %)

This was followed by chemical deodorization at 85° C. To this end, 2.2 g of a 25% aqueous hydrogen peroxide solution (0.11 wt % hydrogen peroxide) were added and stirred in for 5 min. Then, 50% of a feed 3 consisting of 5.49 g of a 9.1 wt % aqueous ascorbic acid solution (0.1 wt % ascorbic acid) and 2.85 g of water were added and stirred in for 10 min, followed by the addition of the remaining 50% of feed 3 and 12.06 g of water. This was followed by cooling down to room temperature and filtration.

### Inventive Example 1

A mixture consisting of 462 g of water, 200 g of spray-dried maltodextrin (DE value 16.5-19.9, 50 wt %), 40 g of feed 1 and 25.6 g of feed 2 was heated to 85° C. and maintained at 85° C. for 15 min. Then, while, maintaining the 85° C. and starting at the same time, the remaining amounts of feeds 1 and 2 were added to the polymerization zone continuously (within 2.5 h for feed 1, within 3 h for feed 2). This was followed by an hour of secondary polymerization at 85° C.
Feed 1: 220 g of n-butyl acrylate (55 wt %)
   172 g of styrene (43 wt %)
   8 g of acrylic acid (2 wt %)
Feed 2: 128 g of 2.5 wt % aqueous solution of sodium peroxodisulfate (0.8 wt %)

This was followed by chemical deodorization at 85° C. To this end, 1.76 g of a 25% aqueous hydrogen peroxide solution (0.11 wt % hydrogen peroxide) were added and stirred in for 5 min. Then, 50% of a feed 3 consisting of 4.4 g of a 9.1 wt % aqueous ascorbic acid solution (0.1 wt % scorbic acid) and 2.28 g of water were added and stirred in for 10 min, followed by the addition of the remaining 50% of feed 3 and 9.64 g of water. This was followed by cooling down to room temperature and filtration.

### Comparative Example 2

A mixture consisting of 200 g of water, 25 g of spray-dried maltodextrin (DE value 16.5-19.9, 5 wt %), 70.6 g of feed 1 and 10.2 g of feed 2 was heated to 85° C. and maintained at 85° C. for 15 min. Then, while maintaining the 85° C. and starting at the same time, the remaining amounts of feeds 1 and 2 were added to the polymerization zone continuously (within 2.5 h for feed 1, within 3 h for feed 2). This was followed by an hour of secondary polymerization at 85° C.
Feed 1: 450 g of n-butyl acrylate (90 wt %)
   40 g of styrene (8 wt %)
   10 g of acrylic acid (2 wt %)
   198 g of water
   7.5 g of 20% Disponil LDBS 20 solution (0.3 wt % of Disponil LDBS 20)
Feed 2: 104.2 g of 2.4 wt % aqueous solution of sodium peroxodisulfate (0.5 wt %)

This was followed by chemical deodorization at 85° C. To this end, 2.2 g of a 25% aqueous hydrogen peroxide solution (0.11 wt % hydrogen peroxide) were added and stirred in for 5 min. Then, 50% of a feed 3 consisting of 5.49 g of a 9.1 wt % aqueous ascorbic acid solution (0.1 wt % ascorbic acid) and 2.85 g of water were added and stirred in for 10 min, followed by the addition of the remaining 50% of feed 3 and 14.89 g of water. This was followed by cooling down to room temperature and filtration.

### Inventive Example 2

A mixture consisting of 200 g of water, 200 g of spray-dried maltodextrin (DE value 16.5-19.9, 40 wt %), 70.5 g of feed 1 and 10.2 g of feed 2 was heated to 85° C. and maintained at 85° C. for 15 min. Then, while maintaining the 85° C. and starting at the same time, the remaining amounts of feeds 1 and 2 were added to the polymerization zone continuously (within 2.5 h for feed 1, within 3 h for feed 2). This was followed by an hour of secondary polymerization at 85° C.
Feed 1: 250 g of n-butyl acrylate (50 wt %)
   225 g of styrene (45 wt %)
   25 g of acrylic acid (5 wt %)
   202 g of water
   7.5 g of 20% Disponil LDBS 20 solution (0.1 wt % of Disponil LDBS 20)
Feed 2: 104.2 g of 2.4 wt % aqueous solution of sodium peroxodisulfate (0.5 wt %)

This was followed by chemical deodorization at 85° C. To this end, 2.2 g of a 25% aqueous hydrogen peroxide solution (0.11 wt % hydrogen peroxide) were added and stirred in for 5 min. Then, 50% of a feed 3 consisting of 5.49 g of a 9.1 wt % aqueous ascorbic acid solution (0.1 wt % ascorbic acid) and 2.85 g of water were added and stirred in for 10 min, followed by the addition of the remaining 50% of feed 3 and 188.89 g of water. This was followed by cooling down to room temperature and filtration.

TABLE 1

| Dispersions - | | | | |
|---|---|---|---|---|
| Freeze-thaw | Comparative | Comparative | Inventive | Inventive |
| stability test | Example 1 | Example 2 | Example 1 | Example 2 |
| Freeze-thaw cycles | | | | |
| 1/24 h at −20° C., | coagulated | coagulated | stable | stable |
| 24 h 23° C. | | | | |
| 2/24 h at −20° C., | — | — | stable | stable |
| 24 h 23° C. | | | | |
| 3/24 h at −20° C., | — | — | stable | stable |
| 24 h 23° C. | | | | |
| 4/24 h at −20° C., | — | — | stable | stable |
| 24 h 23° C. | | | | |
| 5/24 h at −20° C., | — | — | stable | stable |
| 24 h 23° C. | | | | |
| Solids content | 49.5% | 49.4% | 50.0% | 48.2% |

As is evident in Table 1, Inventive Examples 1 and 2 exhibit a stable phase after five cycles at −20° C. for 24 h and 23° C. at 24 h, whereas Comparative Examples 1 and 2 coagulate.

TABLE 2

| | Binder formulation | | | |
|---|---|---|---|---|
| | 1 | 2 | 3 | 4 |
| Comparative Example 1 | 63 | — | — | — |
| Comparative Example 2 | — | 63 | — | — |
| Inventive Example 1 | — | — | 63 | — |
| Inventive Example 2 | — | — | — | 63 |
| Adjusted to pH8 with NaOH | yes | yes | yes | yes |
| Dispex ® CX 4231 | 1 | 1 | 1 | 1 |
| Omyacarb ® 5 GU | 33 | 33 | 33 | 33 |
| Rheovis ® AS 1130 | 3 | 3 | 3 | 3 |
| Total | 100 | 100 | 100 | 100 |
| Test | | | | |
| Freeze-thaw cycles | | | | |
| 1/24 h at −20° C., 24 h 23° C. | stable | stable | stable | stable |
| 2/24 h at −20° C., 24 h 23° C. | stable | coagulated | stable | stable |
| 3/24 h at −20° C., 24 h 23° C. | stable | coagulated | stable | stable |
| 4/24 h at −20° C., 24 h 23° C. | stable | — | stable | stable |
| 5/24 h at −20° C., 24 h 23° C. | stable | — | stable | stable |

| Name of product (in Table 2) | Function | Supplier |
|---|---|---|
| (Comp. Ex. 1-2; Inv. Ex. 1-2) | binder | BASF SE |
| Dispex ® DX 4231 | pigment disperser | BASF SE |
| Omyacarb ® 5 GU | filler | Omya GmbH, |
| | | 50968 Cologne |
| Rheovis ® AS 1130 | thickener | BASF SE |

As is evident in Table 2, binder formulations 1, 3 and 4 of the present invention exhibit a stable phase after five cycles at −20° C. for 24 h and 23° C. at 24 h, whereas Example 2 coagulates.

1-15. (canceled)

16. A method of forming a freeze-thaw-stable aqueous dispersion, the method comprising:
a) providing a mixture A, comprising:
20-79.5 wt % of at least one ester from ethylenically unsaturated monomers A,
20-79.5 wt % of at least one ethylenically unsaturated monomer B other than monomer A,
0.5-5 wt % of at least one acid-functional ethylenically unsaturated monomer C,
wherein the overall amount of monomers A to C is 100 wt %,
b) providing 20-55 wt % of at least one saccharide compound S, based on the amount of monomers A to C to be polymerized, wherein the saccharide compound S is maltodextrin and has DE-values of from 3 to 20 and a weight average molecular 20 weight of from 15000 to 30000 g/mol,
c) providing 20 to 150 wt % water-soluble solvents and/or water W, based on the amount of monomers A to C to be polymerized,
d) providing 0.1-2 wt % of at least one polymerization initiator I, based on the amount of monomers A to C to be polymerized,
e) polymerizing said monomers A to C in the presence of S, W and I to form a polymer P,
wherein the aqueous dispersion is exposed to at least one freeze-thaw process, and wherein said dispersion is free from freeze-thaw-stabilizing additives, which freeze-thaw-stabilizing additives are anionic, cationic or non-ionic emulsifiers.

17. The method of forming a dispersion according to claim 16,
wherein 5-15 wt % of the total of mixture A and 4-8 wt % of the total of polymerization initiator I and 25-35 wt % of the total of water W are provided and polymerized and within 6 h the remainder of mixture A, of polymerization initiator I and of water W is added.

18. A freeze-thaw-stable aqueous dispersion obtained by a method according to claim 16.

19. The method of using a freeze-thaw-stable aqueous dispersion according to claim 18 as a cold- and/or heat-resistant binder for coatings, sealants, cementitious coatings, noncementitious coatings, adhesives, and primers.

20. A method of forming a shaped article from granular and/or fibrous substrates which comprises applying a freeze-thaw-stable dispersion according to claim 18 to the granular and/or fibrous substrate, optionally shaping the granular and/or fibrous substrate thus treated and then subjecting the granular and/or fibrous substrate thus obtained to a 10 thermal treating step at a temperature ≧110° C.

21. A freeze-thaw-stable formulation comprising the freeze-thaw-stable dispersion according to claim 18, at least one pigment disperser, at least one filler and at least one thickener.

22. A freeze-thaw-stable formulation, comprising:
1-99.9 wt % of freeze-thaw-stable aqueous dispersion according to claim 18,
0-5 wt % of at least one pigment disperser,
0-80 wt % of at least one filler,
0.1-10 wt % of at least one thickener, and
0-5 wt % of at least one additive,
wherein the components sum to an overall amount of 100 wt %.

23. The freeze-thaw-stable formulation according to claim 22, consisting of:
1-99.9 wt % of freeze-thaw-stable aqueous dispersion,
0-5 wt % of at least one pigment disperser,
0-80 wt % of at least one filler,
0.1-10 wt % of at least one thickener, and
0-5 wt % of at least one additive,
wherein the components sum to an overall amount of 100 wt %.

24. The method of using a freeze-thaw-stable aqueous dispersion according to claim 22 as a binder for coatings, sealants, cementitious coatings, noncementitious coatings, adhesives, and primers.

25. The method of using a freeze-thaw-stable aqueous dispersion according to claim 23 as a binder for coatings, sealants, cementitious coatings, noncementitious coatings, adhesives, and primers.
